(19) United States
(12) Patent Application Publication
(10) Pub. No.: US 2026/0153409 A1
(43) Pub. Date: Jun. 4, 2026

(54) SYSTEMS AND METHODS FOR PRE-TESTING AND ASSEMBLING SUB-ASSEMBLIES FOR A RETROFITTED MACHINE

(71) Applicant: Caterpillar Inc., Peoria, IL (US)

(72) Inventors: Noah GEORGE, Brimfield, IL (US); Tyler S. MULLEN, Metamora, IL (US); Craig P. HITTLE, Dunlap, IL (US); Jacob LESSEN, Washington, IL (US)

(73) Assignee: Caterpillar Inc., Peoria, IL (US)

(21) Appl. No.: 18/965,255

(22) Filed: Dec. 2, 2024

(51) Int. Cl. G01M 15/04; F02D 41/22

(52) U.S. Cl. CPC G01M 15/044; F02D 41/22

(57) ABSTRACT

Disclosed is a method of testing and assembling a power system of an electric or partial electric machine, the method including: assembling one or more sub-assemblies of the power system; testing one or more of the one or more sub-assemblies of the power system independently; adjusting one or more of the one or more sub-assemblies based on the testing; assembling each sub-assembly in a pre-determined location of the electric or partial electric machine; and testing the assembled power system of the electric or partial electric machine.

### TECHNICAL FIELD

The present disclosure relates generally to electric and partially electric machines, and more particularly, to systems and methods for testing and assembling sub-assemblies for a retrofitted power system of an electric or partially electric machine.

### BACKGROUND

Industrial vehicles or machines, for example, wheel loaders, excavators, trucks (e.g., dump trucks, haul trucks, articulated dump trucks, etc.), track-type tractors (e.g., bulldozers), graders, continuous miners, feeder breakers, roof bolters, utility vehicles for mining, load-haul-dump (LHD) vehicles, underground mining loaders, underground articulated trucks, etc., may be fully electric, partially electric, and non-electric. Electric and partially electric machines include one or more batteries, and non-electric vehicles can be retrofitted or upgraded to include one or more batteries. The one or more batteries include various connections (e.g., electrical connections) in order to power one or more electrical components, for example, motors, heating and/or cooling systems, hydraulic system(s), navigation systems, lighting systems, electronics, auxiliary systems, etc.

Retrofitting existing non-electric machines to electric or partially electric machines can help to provide ecological and environmental benefits, reduce waste, increase fuel efficiency, or increase the expected useful life of existing machines. One cost associated with retrofitting machines is the testing or calibration of new systems for integration into an often previously non-electric machine. These new systems that require testing or calibration include the one or more batteries, a power distribution system for distributing power (e.g., from the one or more batteries or other power source(s) to the one or more electrical components, from the other power source(s) to the one or more batteries, etc.), and the accompanying electrical components themselves.

The power distribution system and electrical components of the present disclosure may solve one or more of the problems set forth above and/or other problems in the art. The scope of the current disclosure, however, is defined by the attached claims, and not by the ability to solve any specific problem.

### SUMMARY

In one aspect, a method of testing and assembling a power system of an electric or partial electric machine includes: assembling one or more sub-assemblies of the power system; testing one or more of the one or more sub-assemblies of the power system independently; adjusting one or more of the one or more sub-assemblies based on the testing; assembling each sub-assembly in a pre-determined location of the electric or partial electric machine; and testing the assembled power system of the electric or partial electric machine.

In another aspect, a power system for an electric or partially electric machine includes: a first sub-assembly including a genset; a second sub-assembly including one or more batteries; and a third sub-assembly including a motor powered by the genset or the one or more batteries, wherein each of the first sub-assembly, the second sub-assembly, and the third sub-assembly is tested separately from each of the others of the first sub-assembly, the second sub-assembly, and the third sub-assembly outside of the electric or partially electric machine, and wherein each of the first sub-assembly, the second sub-assembly, and the third sub-assembly is assembled in the electric or partially electric machine after testing.

In yet another aspect, a method of testing and assembling a power system of an electric or partial electric machine includes: assembling a first sub-assembly including a genset; assembling a second sub-assembly including one or more batteries; assembling a third sub-assembly including a motor powered by the genset or the batteries; testing one or more of the first sub-assembly, the second sub-assembly, and the third sub-assembly independently of each of the others of the first sub-assembly, the second sub-assembly, and the third sub-assembly; adjusting one or more of the first sub-assembly, the second sub-assembly, and the third sub-assembly based on the testing; assembling each of the first sub-assembly, the second sub-assembly, and the third sub-assembly in a respective pre-determined location of the electric or partial electric machine; coupling each of the first sub-assembly, the second sub-assembly, and the third sub-assembly to the others of the first sub-assembly, the second sub-assembly, and the third sub-assembly; and testing the assembled electric or partial electric machine, wherein testing includes providing power to the motor from one of the genset or the batteries.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is an illustration of an exemplary machine, according to aspects of the disclosure.

FIG. 2A is a perspective view of a power system of the machine of FIG. 1

FIG. 2B is a close up view of a portion of the power system of FIG. 2A.

FIG. 3 depicts a schematic diagram of the power system of FIGS. 1-2B.

FIG. 4 is a flowchart of an exemplary method for testing and assembling the power system of FIGS. 1-3.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

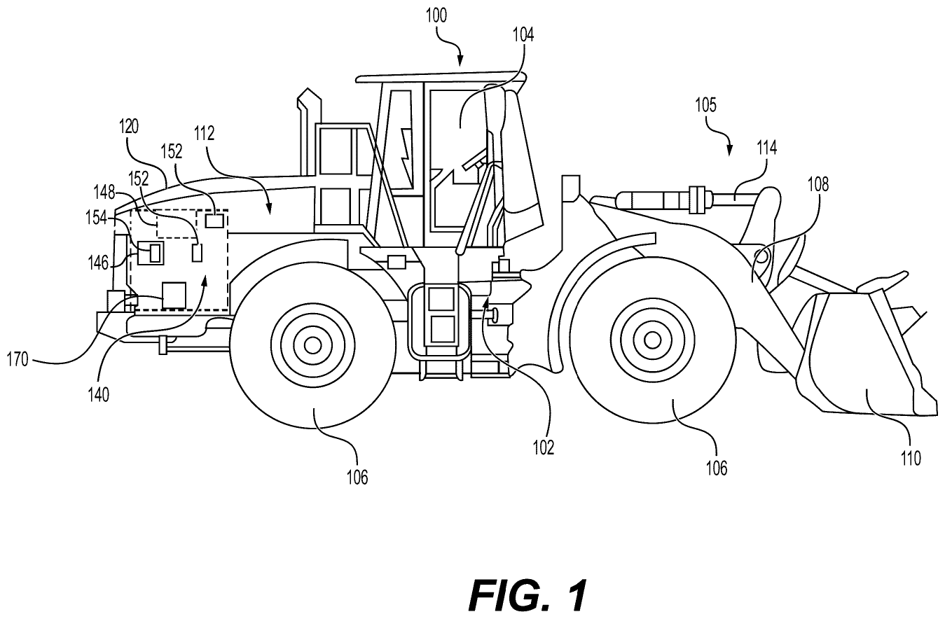

FIG. 1 depicts an exemplary machine 100, for example, a wheel loader. Although machine 100 depicted in FIG. 1 is a wheel loader, machine 100 may be for example, an excavator, a truck (e.g., dump truck, haul truck, articulated dump truck, etc.), a track-type tractor (e.g., bulldozer), a graders, a continuous miner, a feeder breaker, a roof bolter, a utility vehicle for mining, a load-haul-dump (“LHD”) vehicle, an underground mining loader, an underground articulated truck, etc. Machine 100 includes a machine body 102, which may include an operator station or cab 104. Machine 100 may also include an engine housing, engine bay, or cavity 112 (referred to herein at cavity 112), and a prime mover or power system 140, including one or more rechargeable batteries 152. The one or more batteries 152 may power or energize a motor 170 (e.g., to drive wheels 106) and/or other components or systems of machine 100. In some aspects, machine 100 may be fully electric, for example, machine 100 may be fully powered by the one or more batteries 152 of power system 140. Machine 100 may be partially electric (e.g., hybrid), and power system 140 may include a secondary power source, for example, an engine, a genset 148, a fuel cell, etc. The secondary power source may help power or otherwise energize motor 170 to drive wheels 106 and/or power one or more additional components or systems of machine 100. For example, the secondary power source may be used to charge batteries 152 during operation of machine 100. Additionally, in some aspects, the one or more batteries 152 may be removable, for example, to be charged away from machine 100, or to be easily replaced with one or more charged batteries 152. In any of these aspects, charging the one or more batteries 152 or relying on the secondary power source to provide power or otherwise energize various aspects of machine 100 may help to extend the work time of machine 100. In other aspects, the one or more batteries 152 may be charged via a charger (e.g., a plug-in charger) during downtime for machine 100.

Machine 100 may include an implement assembly 105. The implement assembly 105 may include one or more arms 108 and a bucket 110 that may be coupled to an end of arm(s) 108. Although not shown, bucket 110 may also be a different work implement, such as a fork, grapple, etc., and, in some aspects, the work implement may be interchangeable. One or more hydraulic arms (e.g., hydraulic arm 114) may be a part of or otherwise coupled to one or more portions of implement assembly 105 to raise and lower arm 108 and bucket 110, and to tilt bucket 110 toward or away from machine 100. Machine 100 may include ground surface engaging devices, such as wheels 106, which support machine body 12 and are powered by power system 140 including the one or more batteries 152 (e.g., alone or with the secondary power source). In another aspect, machine 100 may instead have tracks (not shown).

Power system 140, including the one or more batteries 152, may be positioned in a rear portion of machine 100. For example, the one or more batteries 152 may be positioned in cavity 112. Rear portion of machine 100 may include a hood 120 to cover or enclose one or more components of power system 140 within cavity 112. Hood 120 is removable or openable, and hood 120 allows for easy and quick access to power system 140, including the one or more batteries 152. Alternatively, one or more portions of power system 140, for example, the one or more batteries 152, may be positioned anywhere on machine 100.

A power distribution unit (“PDU”) 154 may distribute the power generated by power system 140 to motor 170 and other loads, e.g., to hydraulic systems, electrical systems, cooling systems, etc. In an electric or partially electric machine, PDU 154 may further operate to determine the source of drawing power. For example, PDU 154 may be configured to determine whether to draw power from one or more batteries 152, or from genset 148. PDU 154 may further be configured to allow for charging of one or more batteries 152 via charger 162. PDU 154 may be in communication with one or more features or portions of machine 100. PDU 154, and other electronic control modules disclosed herein, may receive inputs and send outputs, for example, in order to operate aspects of machine 100, including monitoring the secondary power source, controlling the power distribution unit, monitoring the state of charge and the batteries, etc. Although not shown, PDU 154 may be coupled to or include one or more memory units, which may contain instructions for PDU 154 to perform these and other operations. PDU 154 may be a separate controller on machine 100, or may be integrated into a central vehicle controller (e.g., a main power or operation controller, etc.). Alternatively, PDU 154 may be integrated into one or more of a battery management system, a motor control module, or another dedicated control module on machine 100.

PDU 154 may embody a single microprocessor or multiple microprocessors that may include systems for performing any of the operations mentioned herein. For example, PDU 154 may include a memory, a secondary storage device, a processor, such as a central processing unit or any other systems for accomplishing a task consistent with the present disclosure. The memory or secondary storage device associated with PDU 154 may be non-transitory computer-readable media that store data and/or software routines that may assist PDU 154 in performing its functions, as discussed below. Further, the memory or secondary storage device associated with PDU 154 may also store data received from the various inputs or sensors associated with machine 100. Numerous commercially available microprocessors can be configured to perform the computational functions of PDU 154. Various other known circuits may be associated with PDU 154, including signal-conditioning circuitry, communication circuitry, hydraulic or other actuation circuitry, and other appropriate circuitry. As discussed herein, PDU 154 may receive various inputs (e.g., from various sensors or user inputs), and based on the various inputs, PDU 154 may perform functions, such as energizing the secondary power source (genset 148), controlling power distribution, and monitoring the state of charge and the batteries, etc.

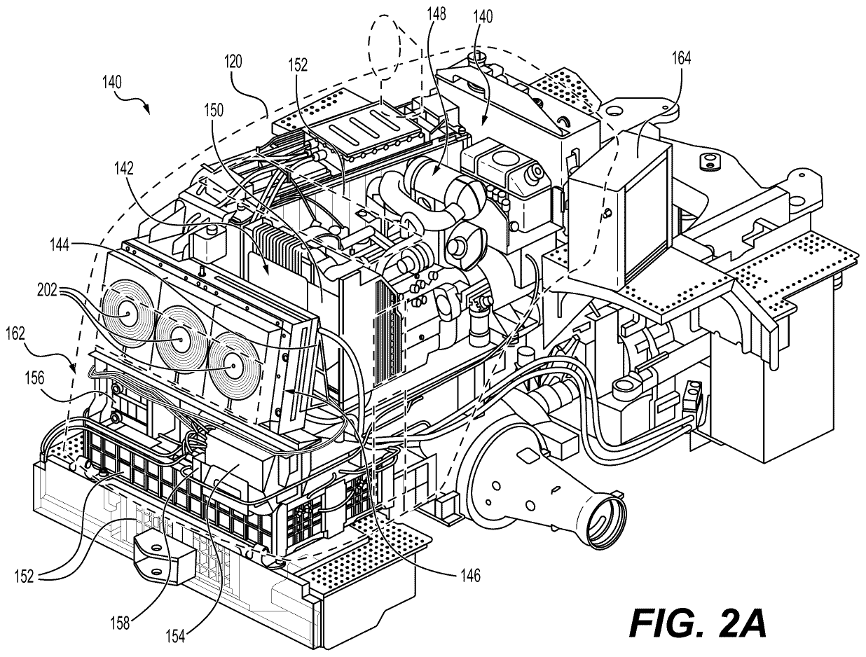

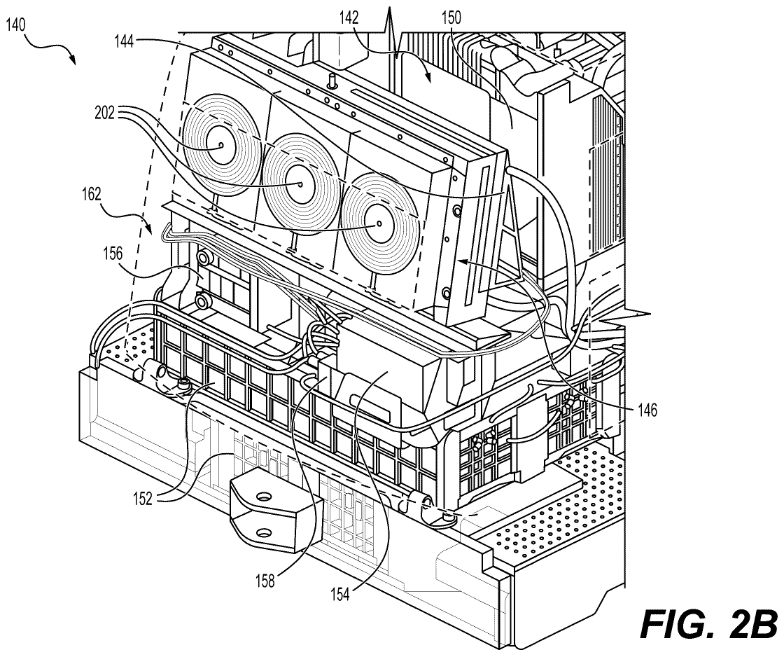

As further described in FIGS. 2A-2B, power system 140 may include a secondary power source, for example, genset 148. Genset 148 may include or otherwise be coupled to a radiator 150. Genset 148 and radiator 150 may be positioned within the front portion of cavity 112. Radiator 150 may be positioned to the rear of the genset 148. Genset 148 may be diesel powered, gasoline powered, etc. Although the secondary power source is discussed as genset 148, in other aspects, secondary power source may be a hydrogen powered engine, a fuel cell, etc.

Power system 140 may further include a power electronics module 146. Power electronics module 146 may be positioned within the rear portion of cavity 112. For example, a central chamber 142 and/or a divider 144 (e.g., a thermally or air-flow insulating shroud) may be positioned between (e.g., along a longitudinal axis of machine 100 or power source 140) genset 148 and power electronic module 146. In these aspects, central chamber 142 and divider 144 may be positioned between (e.g., along a longitudinal axis of machine 100) radiator 150 and power electronics module 146.

Genset 148 may include an internal combustion engine that produces mechanical and/or electrical power output. For example, genset 148 may include a four-stroke diesel engine. Genset 148 may include one or more subsystems, for example, a fuel system, an air induction system, an exhaust system (coupled to an after-treatment system), a lubrication system, a cooling system, and/or the like. Genset 148 may be configured to produce a torque output directed to a transmission and/or to other parasitic loads (e.g., to hydraulic systems, electrical systems, cooling systems, etc.) via, for example, PDU 154.

Power system 140 may include a battery thermal management system (“BTMS” 164) to help regulate the temperature of the one or more batteries 152, for example, to help prevent deterioration or improve performance. BTMS 164 may be positioned within or outside cavity 112. For example, BTMS 164 may be positioned within the front portion of cavity 112 or adjacent to the front portion.

Power system 140 may further include PDU 154, a DC-to-DC (“DC-DC”) converter 156, an AC-to-DC (AC-DC) inverter 158, a gearbox 160, and an on-board charging station (e.g., charger 162). PDU 154, converter 156, and inverter 158 may be positioned within the rear portion of the cavity 112 and/or below power electronics module 146. Hood 120 is removable from machine 100 and allows for easy and quick access to power electronics module 146, genset 148, the one or more batteries 152, PDU 154, converter 156, inverter 158, and other components accommodated in cavity 112. PDU 154 receives and distributes energy from the batteries 152 and secondary power source to the motor 170 and other components of the machine 100. Charger 162 may be positioned to the rear of central chamber of cavity 112 below and/or within the rear portion of the cavity 112. Gearbox 160 may be positioned within the front portion of the cavity 112.

The one or more batteries 152 of power system 140 may be positioned within cavity 112. For example, the one or more batteries 152 may include three batteries 152. One or more of the batteries 152 may be positioned within the front portion of the cavity 112. For example, one or more of batteries 152 may be adjacent to genset 148. Further, one or more of batteries 152 may be positioned within the rear portion of the cavity 112. For example, one or more batteries 152 may be positioned under one or more of power electronics module 146, PDU 154, converter 156, or inverter 158. The one or more batteries 152 may be lithium ion phosphate batteries. However, in other aspects, the one or more batteries 152 may be any type of battery for powering electric or partially electric vehicles or machines. Each of the one or more batteries 152 may include a plurality of battery cells (e.g., a battery pack or a battery string).

Power electronics module 146, genset 148, the one or more batteries 152, PDU 154, converter 156, inverter 158, and charger 162 may, in some examples, be introduced into machine 100 as part of a retrofit or modification of machine 100 from a non-electric machine to an electric or partially electric machine. Hood 120 is removable from machine 100 and allows for easy and quick access to cavity 112. As such, power electronics module 146, genset 148, the one or batteries 152, PDU 154, converter 156, inverter 158, and other components accommodated in cavity 112, may all be installed within cavity 112, such that they are easily removable and replaceable.

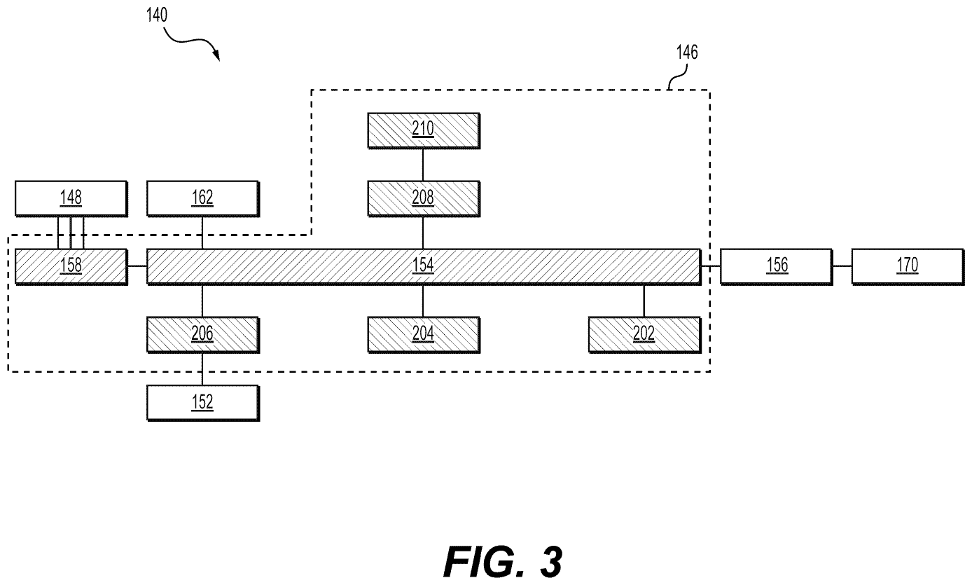

As discussed above, a significant cost associated with retrofitting machine 110 to an electric or partially electric machine is often the testing or calibration of new systems for integration into a previously non-electric machine. In particular, electrical sub-assemblies, such as those shown in FIG. 3, often require testing or calibration.

FIG. 3 depicts a schematic diagram of power system 140, with multiple electrical assemblies and sub-assemblies. PDU 154 is the electrical hub of power system 140. In one aspect, PDU 154 receives power from genset 148 or batteries 152, and distributes the power to one or more loads, such as motor 170, one or more fans 202, one or more compressors 204, and one or more low voltage systems 210, such as user interfaces, electronic systems, etc. Additionally, PDU 154 may distribute power from chargers 162 to batteries 152, or from genset 148 to batteries 152. Genset 148 is connected to PDU 154 via inverter 158, and motor 170 is connected to PDU 154 via converter 156. In these aspects, genset 148 may produce power having AC current, and motor 170 may receive power in the form of DC current. Batteries 152 may be connected to PDU 154 via a mechanical safety disconnect (“MSD”) 206. MSD 206 helps to allow for quick, mechanical, disconnecting of batteries 152 from PDU 154 and other electrical components for safety or maintenance. Disconnecting the batteries 152 from PDU 154 via MSD 206 helps to result in both physical and electrical disconnection, such that the batteries 152 are effectively isolated from all electrical systems of power system 140 when disconnected via MSD 206. Low voltage systems 210 may be connected to PDU 154 via a low-voltage DC-DC converter 208. Converter 208 provides low voltage systems 210 with the necessary and appropriate voltage drop necessary for operation of the low voltage systems 210.

Each element depicted in FIG. 3 may be individually tested and calibrated outside cavity 112 before assembly of power source 140 of machine 100. Additionally, each element depicted in FIG. 3 may be individually removed from cavity 112, tested, calibrated, and replaced in cavity 112. Also, sub-assemblies of the elements in FIG. 3 may be tested and calibrated outside cavity 112 before assembly of power source 140 of machine 100. For example, genset 148, inverter 158, and PDU 154 may comprise one such sub-assembly. In another example, genset 148 and inverter 158 may comprise another such sub-assembly. In another example, batteries 152, MSD 206, and PDU 154 may comprise another such sub-assembly. In another example, batteries 152, MSD 206, PDU 154, and charger 162 may comprise another such sub-assembly. Any combination of the elements shown in FIG. 3 may comprise a sub-assembly that is separately tested and placed in cavity 112. Additionally, any sub-assembly of elements described in FIG. 3 may be removed from cavity 112 as a sub-assembly, tested, calibrated, and replaced in cavity 112.

### INDUSTRIAL APPLICABILITY

The disclosed aspects of power system 140 of the present disclosure may be applied to any electric or partially electric machine or vehicle, such as a wheel loader retrofitted from a non-electric wheel loader to be an electric or partially electric wheel loader. During a retrofit, components of a non-electric machine or vehicle are removed and replaced with electrical sub-assemblies that require testing or calibration. Power system 140 of the present disclosure helps to allow for pre-tested electrical sub-assemblies to be quickly and efficiently tested, calibrated, or installed within cavity 112 of machine 100.

As discussed above, the power system 140 includes modular sub-assemblies of pre-tested power electronics that may be tested off or separate from machine, then placed directly into cavity 112 of machine 100, with options to move components for different machine configurations. Furthermore, providing the power electronics module 146 near the rear of the rest of the power system 140 helps to allow for quick and efficient removal of power electronics module 146 for, for example, inspection, service, testing and replacement. Thus, power system 140, including power electronics module 146, helps to allow for convenient, efficient, space-saving and cost-effective retrofitting of existing non-electric machines to electric or partially electric machines.

Pre-assembly quality checks may be conducted on components or sub-assemblies before installation into machine 100, allowing for more efficient quality checks. Pre-assembly quality checks also help to reduce the need for shutting down machine 100 to perform maintenance and the time- and labor-intensive process of removing components or sub-assemblies from machine 100 and replacing components or sub-assemblies back into machine 100.

Retrofitting existing non-electric machines to electric or partially electric machines helps to provides ecological and environmental benefits, helps to increase fuel efficiency, and helps to increase the expected useful life of existing machines. Existing machines potentially would have otherwise been required to be retired or scrapped if retrofitting proved too costly.

The disclosed power system 140, including power electronics module 146, may be implemented in existing and future machines. In particular, the disclosed power system may be implemented in existing machines (e.g., in a retrofitting procedure) that have been converted or are being converted from fuel-burning machines to at least partially electric machines without regard to the type of fuel burned by an engine of the machine or the genset.

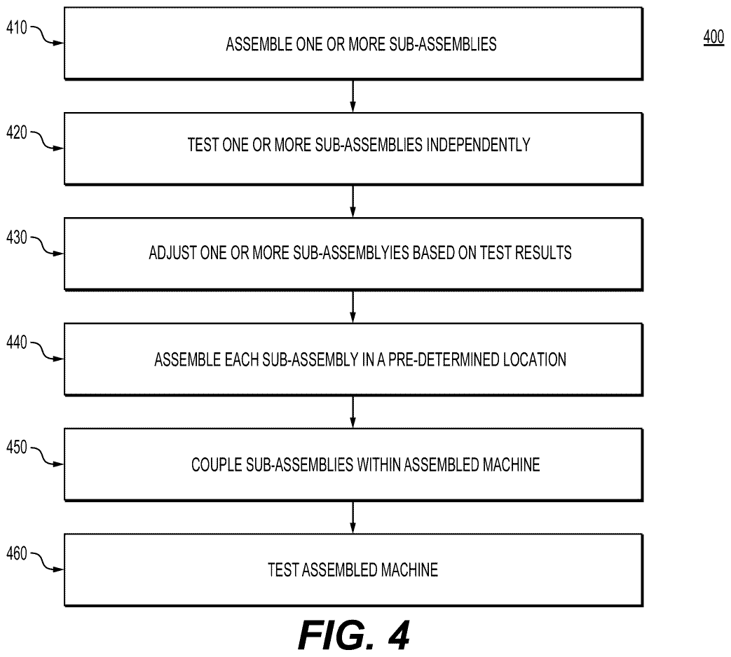

FIG. 4 illustrates steps of a method 400 of testing and assembling a power system, for example, power system 140, of an electric or partial electric machine 100. At a step 410, method 400 includes assembling one or more sub-assemblies, for example, of power system 140. As discussed above, a sub-assembly may include any number of elements shown in FIG. 3. Some sub-assemblies may include, for example: genset 148 and inverter 158; batteries 152 and MSD 206; low-voltage systems 210 and low-voltage converter 208; motor 170 and converter 156; fan(s) 202 and compressor(s) 204; genset 148, inverter 158, and PDU 154; batteries 152, charger 162, and PDU 154; etc.

At a step 420, method 400 includes testing one or more of the sub-assemblies independently. A sub-assembly may include a single element, such that step 420 may also include testing any element of FIG. 3 independently. Alternatively, as mentioned, a sub-assembly may include two or more elements, such that step 420 includes testing the two or more elements. Testing may be performed outside of machine 100, for example, on a test stand. Testing may include calibration of the element or sub-assembly for use with other elements of power system 140, and may include testing the hardware and software associated with each element or sub-assembly for compatibility with the hardware and software of other sub-assemblies of power system 140, or more generally of machine 100.

At a step 430, method 400 includes adjusting one or more sub-assemblies based on the test results from step 420. Adjustments may be made to electrical aspects of each sub-assembly, to software of each sub-assembly, for example, installing patches or updates to the software of each element or sub-assembly, etc.

At a step 440, method 400 includes assembling each sub-assembly in a pre-determined location. The sub-assemblies of power system 140, as discussed above, may be disposed within cavity 112 of machine 100. Cavity 112 may have a removable hood 120, such that each element and sub-assembly may be easily installed, removed, and replaced within cavity 112.

At a step 450, method 400 incudes coupling each of the sub-assemblies to each other. Coupling the sub-assemblies to each other may include providing electrical connections between sub-assemblies of power system 140 via PDU 154. Coupling the batteries 152 to the other sub-assemblies may include connecting MSD 206 between batteries 152 and PDU 154. Other sub-assemblies of power system 140 may also include mechanical safety disconnects between the respective element and PDU 154. In some examples, step 440 and step 450 may be combined into a single step including assembling and electrically coupling the sub-assemblies.

At a step 460, method 400 includes testing the entire machine 100, for example, with the assembled power system 140 within cavity 112 of machine 100. Testing of machine 100 may include, for example, testing use of implement assembly 105. In other aspects, testing of machine 100 may include testing of low-voltage systems 210, fans 202, compressor 204, etc. Testing may also include sending and receiving sample messages via a user interface (not shown) in cab 104. Alternatively or additionally, testing may include testing appropriate distribution of power to and from PDU 154. Testing of distribution of power may include testing of flow of power from charger 162 to batteries 152 via PDU 154, or from genset 148 to batteries 152. Testing of distribution of power may also include testing of flow of power from power sources to loads. Power sources may include genset 148 and batteries 152, while loads include motor 170, fans 202, compressors 204, and low-voltage systems 210.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A method of testing and assembling a power system of an electric or partial electric machine, the method comprising:
assembling one or more sub-assemblies of the power system;
testing one or more of the one or more sub-assemblies of the power system independently;
adjusting one or more of the one or more sub-assemblies based on the testing;
assembling each sub-assembly in a pre-determined location of the electric or partial electric machine; and
testing the assembled power system of the electric or partial electric machine.

2. The method of claim 1, wherein one of the one or more sub-assemblies includes a genset and an inverter.

3. The method of claim 1, wherein one of the one or more sub-assemblies includes one or more batteries and a mechanical safety disconnect (“MSD”).

4. The method of claim 1, wherein one of the one or more sub-assemblies includes a motor and a DC-to-DC converter.

5. The method of claim 1, wherein one of the one or more sub-assemblies includes a low-voltage load and a low-voltage DC-to-DC converter.

6. The method of claim 1, wherein the pre-determined location is in an existing engine cavity of the machine.

7. The method of claim 6, wherein testing the assembled power system includes one or more of: sending power from a genset to a motor; sending power from one or more batteries to the motor; or sending power from the genset to the one or more batteries.

8. The method of claim 1, wherein the adjusting each of the one or more sub-assemblies includes updating software of one or more elements of the one or more sub-assemblies.

9. A power system for an electric or partially electric machine, comprising:
a first sub-assembly including a genset;
a second sub-assembly including one or more batteries; and
a third sub-assembly including a motor powered by the genset or the one or more batteries,
wherein each of the first sub-assembly, the second sub-assembly, and the third sub-assembly is tested separately from each of the others of the first sub-assembly, the second sub-assembly, and the third sub-assembly outside of the electric or partially electric machine, and wherein each of the first sub-assembly, the second sub-assembly, and the third sub-assembly is assembled in the electric or partially electric machine after testing.

10. The power system of claim 9, wherein the first sub-assembly further includes an inverter, and wherein the genset and inverter are tested together outside of the electric or partially electric machine.

11. The power system of claim 9, wherein the second sub-assembly further includes a mechanical safety disconnect (“MSD”), and wherein the one or more batteries and the MSD are tested together outside of the electric or partially electric machine.

12. The power system of claim 9, wherein the third sub-assembly further includes a DC-to-DC converter, and wherein the motor and the DC-to-DC converter are tested together outside of the electric or partially electric machine.

13. The power system of claim 9, further including a power distribution unit (“PDU”) for distributing power from the genset and the one or more batteries to one or more loads.

14. The power system of claim 13, further including one or more chargers, wherein the one or more chargers are connected to the one or more batteries via the PDU.

15. The power system of claim 13, wherein the one or more loads includes a motor, a fan, or a compressor.

16. The power system of claim 9, wherein the first sub-assembly, the second sub-assembly, and the third sub-assembly are assembled in an existing engine cavity.

17. The power system of claim 16, wherein a removable hood covers the cavity.

18. A method of testing and assembling a power system of an electric or partial electric machine, the method comprising:
assembling a first sub-assembly including a genset;
assembling a second sub-assembly including one or more batteries;
assembling a third sub-assembly including a motor powered by the genset or the batteries;
testing one or more of the first sub-assembly, the second sub-assembly, and the third sub-assembly independently of each of the others of the first sub-assembly, the second sub-assembly, and the third sub-assembly;
adjusting one or more of the first sub-assembly, the second sub-assembly, and the third sub-assembly based on the testing;
assembling each of the first sub-assembly, the second sub-assembly, and the third sub-assembly in a respective pre-determined location of the electric or partial electric machine;
coupling each of the first sub-assembly, the second sub-assembly, and the third sub-assembly to the others of the first sub-assembly, the second sub-assembly, and the third sub-assembly; and
testing the assembled electric or partial electric machine, wherein testing includes providing power to the motor from one of the genset or the batteries.

19. The method of claim 18, wherein the pre-determined location is in an existing engine cavity in the machine.

20. The method of claim 19, wherein testing the assembled power system includes one or more of: sending power from the genset to the motor; sending power from the one or more batteries to the motor; or sending power from the genset to the batteries.
